(19) United States
(12) Patent Application Publication
(10) Pub. No.: US 2012/0324068 A1
(43) Pub. Date: Dec. 20, 2012

(54) DIRECT NETWORKING FOR MULTI-SERVER UNITS

(75) Inventors: Ajith Jayamohan, Redmond, WA (US); Suyash Sinha, Kirkland, WA (US); Sreenivas Addagatla, Redmond, WA (US); Mark E. Shaw, Sammamish, WA (US)

(73) Assignee: MICROSOFT CORPORATION, Redmond, WA (US)

(21) Appl. No.: 13/163,432

(22) Filed: Jun. 17, 2011

(51) Int. Cl. G06F 15/177

(52) U.S. Cl. 709/222

(57) ABSTRACT

Embodiments related to a multi-server unit having a direct network topology are disclosed. For example, one disclosed embodiment provides a multi-server unit including a plurality of server nodes connected in a direct network topology including distributed switching between the plurality of server nodes. The plurality of server nodes further comprises a router server node having one or more ports configured to communicate with an outside network, one or more ports configured to communicate with other server nodes of the plurality of server nodes, a logic subsystem, and instructions executable to implement a router configured to direct traffic between the one or more ports configured to communicate with an outside network and the one or more ports configured to communicate with other server nodes of the plurality of server nodes via the direct network.

### BACKGROUND

Servers in data centers may be arranged in multi-server units having a “top of the rack” (ToR) switch that connects to aggregator switches and other network components in a tree topology. The ToR switch has direct connections to all servers in the corresponding multi-server unit, such that all intra-unit and inter-unit traffic passes through the ToR switch. Such topologies may have high oversubscription in terms of network upstream and downstream bandwidth. This may result in increased latency during period of high usage, which may affect service level agreements of external network-based services.

One potential method to address oversubscription-related latencies may be to increase the bandwidth of a data center network, for example, by upgrading from 1 Gb Ethernet to 10 Gb Ethernet. However, the costs of such upgrades may be high at least in part due to the costs associated with 10 Gb Ethernet ToR switches.

### SUMMARY

One disclosed embodiment provides a multi-server unit comprising a plurality of server nodes connected in a direct network topology comprising distributed switching between the plurality of server nodes. The plurality of server nodes further comprises a router server node having one or more ports configured to communicate with an outside network, one or more ports configured to communicate with other server nodes of the plurality of server nodes, and instructions executable by the router server node to implement a router configured to direct traffic between the one or more ports configured to communicate with an outside network and the one or more ports configured to communicate with other server nodes of the plurality of server nodes via the direct network.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 shows an embodiment of a plurality of multi-server units each comprising multiple servers connected to a top-of-the-rack switch.

FIG. 2 shows the embodiment of FIG. 1 after replacement of one of the multi-server units with an embodiment of a direct network multi-server unit.

FIG. 3 shows the embodiment of FIG. 1 after replacement of both multi-server units with embodiments of direct network multi-server units.

FIG. 4 shows an embodiment of a direct network interface device.

FIG. 5 shows an embodiment of a distributed switch connection management architecture.

FIG. 6 shows a first example embodiment of a direct network topology for a multi-server unit.

FIG. 7 shows a second example embodiment of a direct network topology for a multi-server unit.

FIG. 8 shows a flow diagram depicting an embodiment of a method of operating a multi-server unit.

FIG. 9 shows a block diagram depicting an example embodiment of a computing device.

### DETAILED DESCRIPTION

In current data center configurations, servers are arranged in multi-server organizational units that also include ToR switches, managed power supplies and potentially other components. Such a multi-server unit also may be referred to as a “pod.” Each multi-server unit includes a single OSI (Open Systems Interconnection) layer two ToR switch that connects to all servers in the multi-server unit and provides one or more (often two) uplinks to the next higher level switch, which may be referred to as an Aggregator Core Switch. The Aggregator Core switches may be provided in pairs for redundancy. The servers in such a multi-server unit are arranged in an “indirect network,” as all servers in the multi-server unit are connected to the ToR switch, rather than directly to other server nodes.

Such a data center configuration is slowly moving towards higher bandwidth-capable network designs, where 1 Gb Ethernet downstream ports are replaced with a 10 Gb Ethernet interface. However, this upgrade requires the ToR switches to be upgraded to support 10 Gb Ethernet across all ports available in the switch (e.g. 48 ports in some switches) while providing the same 2× 10 Gb Ethernet uplink to the core switches. Due to the expense of the 10 Gb Ethernet cost structure, emergence of this new model in the data center is slow. Further, while this model may provide increased bandwidth upstream and downstream, bi-section bandwidth within such a multi-server unit still may be less than desired.

Therefore, embodiments are disclosed herein that relate to high-speed data networks with increased bi-section bandwidth compared to traditional tree-based data center networks. The disclosed embodiments connect server nodes in a multi-server unit in a direct network topology with distributed switching between the nodes. The term “direct network” refers to an arrangement in which each server node is directly connected to other server nodes via distributed switching, rather than through a single ToR switch. Such a topology provides a connection-oriented model that interconnects all server nodes within the multi-server unit for high bi-section bandwidth within the multi-server unit, as well as high upstream/downstream bandwidths. Examples of suitable direct network protocols may include, but are not limited to, Light Peak (sold under the brand name Thunderbolt by the Intel Corporation of Santa Clara, Calif.) and Peripheral Component interconnect Express (“PCIe”). It will be understood that, in various embodiments, electrical and/or optical connections may be utilized between server nodes.

The disclosed embodiments further utilize a selected server of the multi-server unit as an OSI level three software-implemented router that routes traffic into and out of the multi-server unit. This is in contrast to the conventional tree-structured data center network, in which an OSI level two switch routes traffic both within the multi-server unit and into/out of the multi-server unit. Thus, in addition to a direct network connection to other server nodes in the multi-server unit, the selected server also includes one or more 10 Gb Ethernet connections to bridge the direct network nodes within the multi-server unit to an external Ethernet network. Further, in some embodiments, components such as a General Purpose Graphics Processing Unit (GPGPU) and/or a Field Programmable Gate Array (FPGA) may be utilized in the selected server to accelerate the software router. The use of a server configured as a router allows a ToR switch to be omitted from the multi-server unit, which may help to reduce costs.

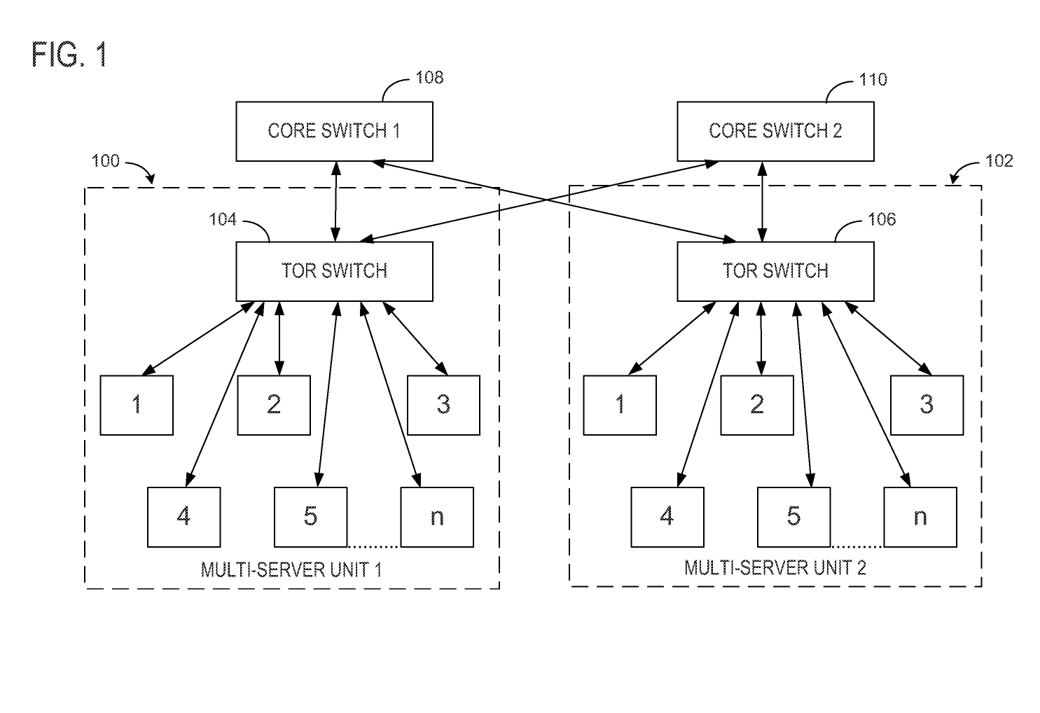

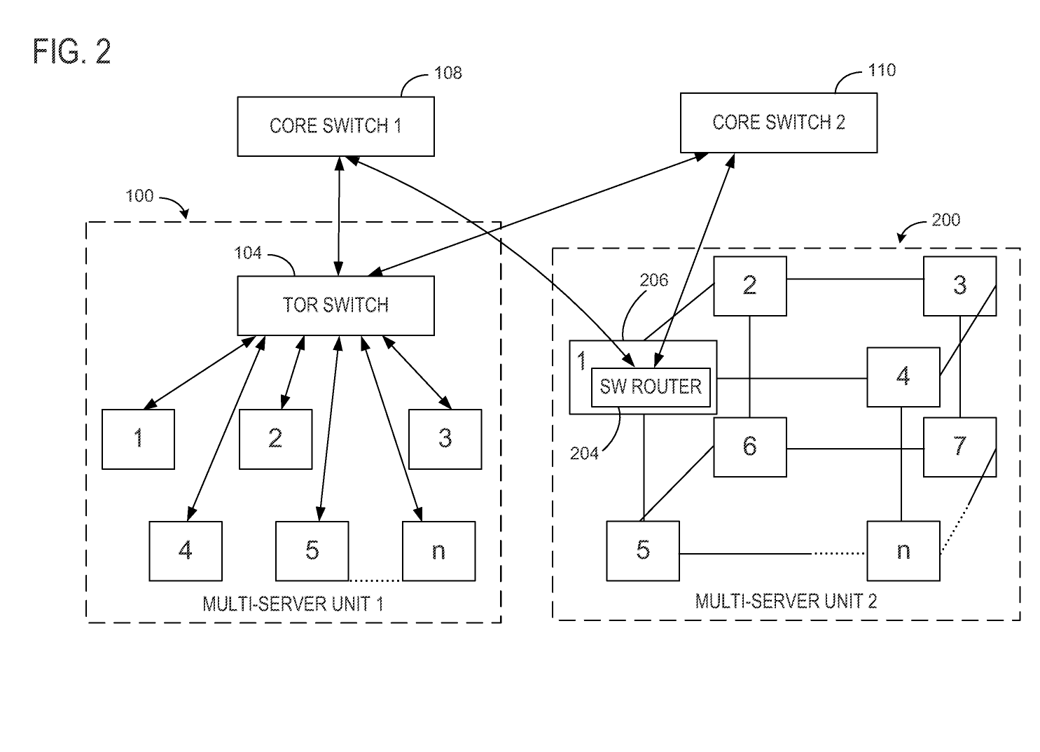

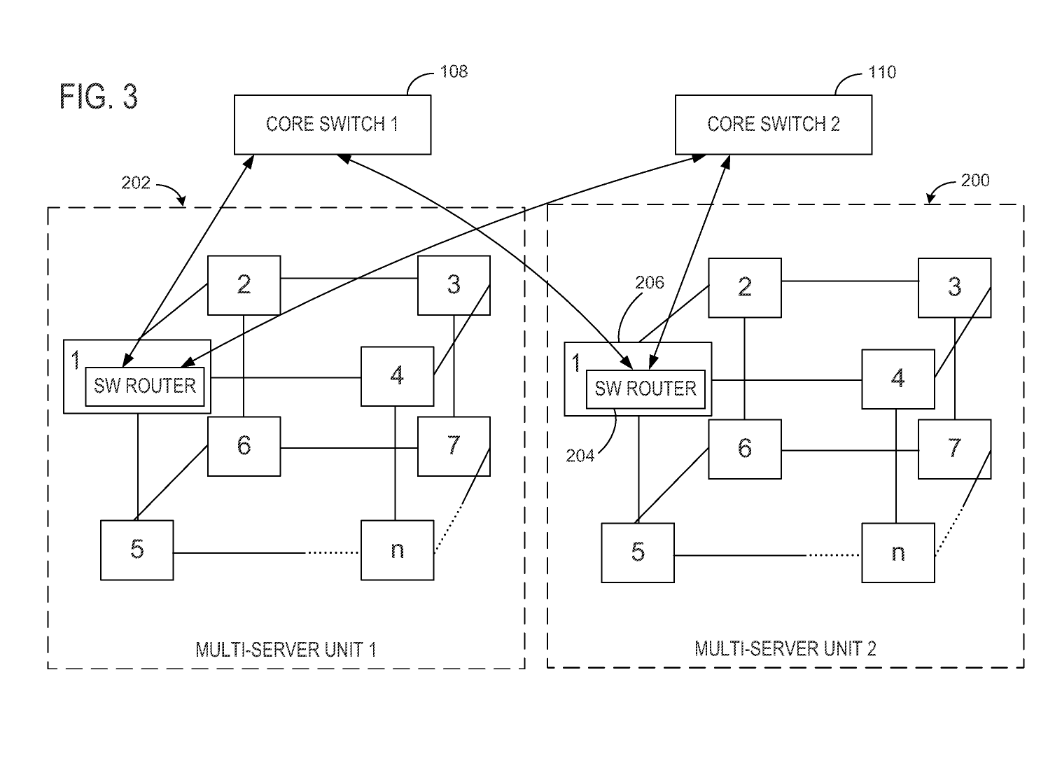

The disclosed multi-server unit embodiments may be deployed as field-replaceable units that are fully compatible with current data center network environments to allow a data center to be upgraded progressively as dictated by needs and budget. FIGS. 1-3 show block diagrams illustrating the progressive replacement of conventional tree-arranged multi-server units in a data center network with embodiments of direct network multi-server units. It will be understood that the specific arrangements of servers in the multi server unit of FIGS. 1-3 is shown for the purpose of example, and is not intended to be limiting in any manner. For example, while a current tree-based multi-server unit in a data center may have a relatively high number of servers (e.g. forty five servers) arranged under a ToR switch, a much smaller number of servers is shown in FIGS. 1-3 for clarity. Additionally, while the example direct network of FIGS. 2-3 is shown having a cube topology with three edges per node, it will be understood that this topology is shown for simplicity, and that any suitable topology may be employed, depending upon a number of direct network ports on each server node and a number of server nodes used. Examples of suitable direct network topologies include, but are not limited to, cube topologies, mesh topologies, butterfly topologies, wrapped butterfly topologies, and Cayley graph topologies. It will likewise be understood that each edge of the direct networks shown at 200 and 202 in FIGS. 2-3 may represent an optical connector, an electrical connector, combinations thereof, and/or any other suitable connector.

FIG. 1 shows a block diagram of embodiments of two multi-server units 100, 102 each comprising an arbitrary number n of server nodes respectively connected to ToR switches 104, 106. Each ToR switch is connected to two core switches 108, 110 for redundancy. Core switches 108, 110 connect to further upstream network components (not shown). Other multi-server unit components, such as power management systems, are omitted for clarity.

In the depicted embodiment, each server node is connected only to the ToR switch for that multi-server unit. Thus, any intra-unit traffic flowing between servers within a multi-server unit passes through the ToR switch. As a result, bandwidth for intra-unit traffic is limited to that of the specific path leading from the sending server node to the ToR switch and then to the receiving server node. Further, because the depicted architecture allows for only a single path between any two server nodes within a multi-server unit, if a path is broken, communication between the two servers connected by the path is disrupted until the broken path is repaired.

FIG. 2 shows the embodiment of FIG. 1 after replacement of tree-based multi-server unit 102 with a direct network-based multi-server unit 200, and FIG. 3 shows the embodiment of FIG. 1 after replacement of multi-server unit 100 with direct network-based multi server unit 202. While the depicted embodiment is described with reference to multi-server unit 200, it will be understood that the discussion also applies to multi-server unit 202.

Multi server unit 200 comprises connections to core switches 108, 110, and thus utilizes the same upstream connections as multi-server unit 102. However, multi-server unit 200 also comprises a direct network of n server nodes arranged such that multiple paths may be defined between any two server nodes in the direct network, thereby providing for greater bi-section bandwidth and fault tolerance than the tree-based architecture of multi-server unit 102, as data may be directed along multiple paths between two intra-unit server nodes.

Further, as will be explained in more detail below, one or more server nodes may be configured to act as a connection manager to manage distributed switching between the server nodes of multi-server unit 200. The connection manager may monitor traffic along all paths in the distributed network, and provision paths between server nodes, for example, as network traffic patterns and bandwidth usage change, if a path becomes broken, or based upon other such considerations. The resulting fault tolerance of the direct network may help to increase network resiliency compared to conventional tree-based multi-server unit topologies. The depicted topology also may help to enable scaling of the network through quality-of-service (QoS) aware network resource management in software.

As mentioned above, any suitable protocol may be used for communication between server nodes within the direct network, including but not limited to Light Peak. In particular, a Light Peak-based interconnect supports direct networks with programmable graph topologies that allow for flexible network traffic provisioning and management capabilities within a multi-server unit, unlike tree topologies. Further, Light Peak provides for optical communication that offers up to 10 Gbps of throughput, with cable lengths of up to 100 in, and with potential upgrades to higher data rates in the future.

Multi-server unit 200 further comprises the aforementioned software router 204 on a selected server node 206. Thus, selected server node 206 acts as an interface between the direct network nodes within the multi-server unit and an external Ethernet (or other) network within the data center. As mentioned above, software router 204 replaces the ToR switch, and acts to bridge server nodes within multi-server unit 200 with the upstream network. The use of software router 204 thus allows the omission of a ToR switch to connect multi-server unit 200 to the upstream network, and therefore may help to reduce costs compared to a multi-server unit having a 10 Gb Ethernet Tor switch.

As mentioned above, in some embodiments, software router 204 may include a GPU and/or FPGA accelerator. Such devices are adapted for performing parallel processing, and thus may be well-suited to perform parallel operations as an IPv4 (Internet Protocol v 4), IPv6 or other forwarder. In such a role, the GPU and/or FPGA may validate packet header information and checksum fields, and gather destination IP/MAC network addresses for incoming and outgoing packets respectively. Further, software router 204 may be configured to have other capabilities, such as IPSec (Internet Protocol Security) tunnels for secure communication. Likewise, a GPU and/or FPGA may be used for cryptographic operations (e.g. AES (Advanced Encryption Standard) or SHA1).

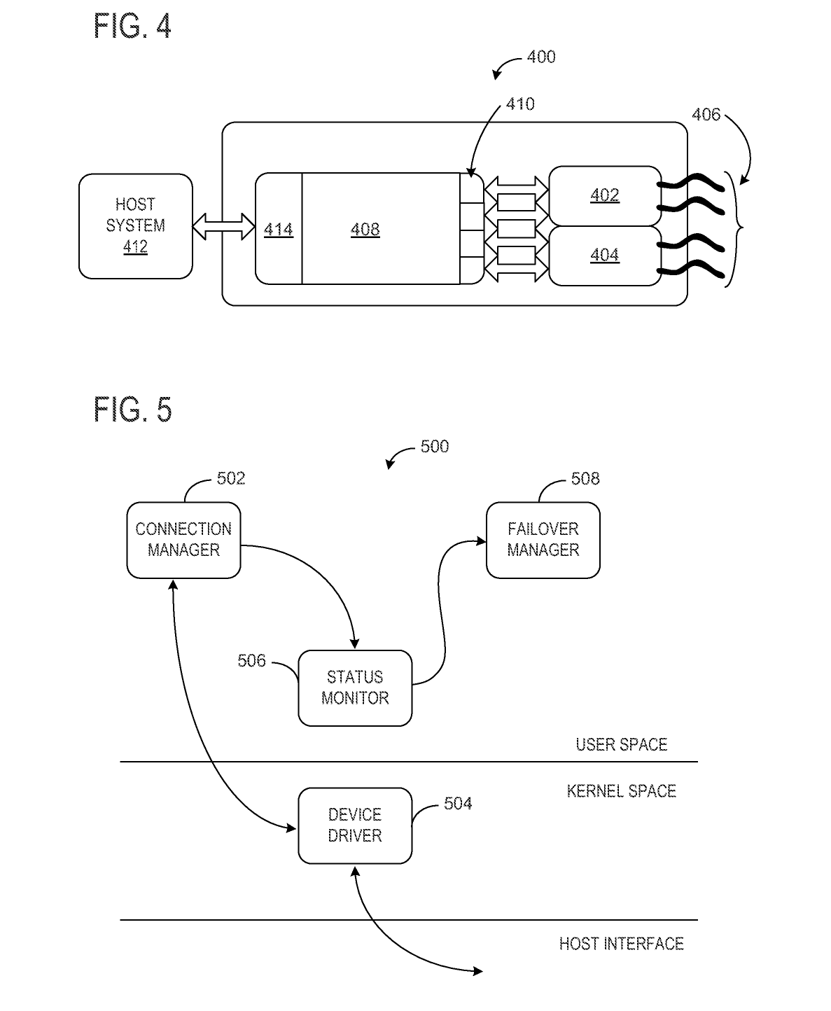

FIG. 4 shows an example embodiment of a direct network interface 400 having two pairs of network transceivers, thereby allowing a server node to be connected to four other server nodes. More specifically, network interface 400 comprises two 10 Gb optical transceiver pairs 402. 404 that are connected to four 10 Gb optical fibers 406. Transceiver pairs 402, 404 provide electrical-to-optical conversion, and are each connected to a Light Peak non-blocking switch 408 via four 10 Gb ports 410. Traffic from non-blocking switch 408 that is destined for host server node 412 is provided to host server node 412 via host interface 414. Likewise, traffic that is destined for a different server node is directed via non-blocking switch 408 to the intended server node. In the specific example of where network interface 400 comprises a PCIe host interface and the above-described 10 Gb Light Peak direct network ports, non-blocking switch 408 may deliver an aggregate bandwidth of 80 Gbps (40 Gbps receive and 40 Gbps transmit) through the optical ports, and 10 Gbps to/from host server node 412. Further, traffic from one optical port to another optical port may be transmitted directly, without any interaction with the host server node processor.

Host server node 412 may comprise software stored in a data-holding subsystem on the host server node 412 that is executable by a logic system on the host server node 412 to manage connections within the direct network. In some embodiments, a plurality of server nodes in a multi-server unit may comprise such logic, thereby allowing the server node performing connection management to be changed without impacting previous path configurations and data transfer.

FIG. 5 shows an embodiment of a connection management system 500 for managing intra-unit connections and data transfer in a direct network multi-server unit. The depicted connection management system 500 comprises a connection manager 502 running in a user space of host server node 412, and a device driver 504 running in a kernel space of host server node 412. Connection manager 502 is configured to manage a network of distributed switches within a “domain,” which may correspond to all distributed switches in a multi-server unit or a subset of switches in the multi-server unit. Connection manager 502 is administratively associated with one of the server node distributed network interfaces, which may be referred to as a Root Switch. The connection manager 502 may be responsible for various tasks, such as device enumeration, path configuration, QoS and buffer allocations at the switches in its domain.

Starting from the Root Switch, connection manager 502 may enumerate each switch in the domain, building a topology graph. Connection manager 502 also receives notification of topology changes caused, for example, by hot-plug and hot-unplug events. After initial enumeration, connection manager 502 may configure paths to enable data communication between server nodes. Path configuration may be performed at initialization time, or on demand based on network traffic patterns.

Multiple domains may be interconnected in arbitrary fashion. Light Peak configuration protocol provides primitives that enable communication between connection managers in adjacent domains, and the connection managers of the adjacent domains may exchange information with each other to perform inter-domain configuration of paths.

Continuing with FIG. 5, connection management system 500 comprises a device driver 504 responsible for sending and receiving network traffic. In the depicted embodiment, device driver 504 is depicted as a system kernel component that interacts with the TCP/IP subsystem on the host on one side and communicates with the host interface on the other side. Device driver 504 also may be responsible for the initialization, configuration, updates and shutdown of host interface 414 and non-blocking switch 408.

Host interface 414 may provide access to the network interface's status registers, and may be configured to read/write to areas of host server node's memory using direct memory access. Host interface 414 may implement support for a pair of producer-consumer queues (one for transmit, one for receive) for each configured path. Host interface 414 may further present a larger protocol data unit that may be used by software to send and receive data.

In addition to interfacing with the operating system TCIP/IP stack, device driver 504 also may export a direct interface to send and receive data directly from user space (e.g. by the connection manager).

Connection management system 500 further comprises a link/switch status monitor 506. Status monitor 506 may be configured to get updates from connection manager 502 regarding events related to network interface 400 and link failures within its domain. Status monitor 506 also may be configured to instruct connection manager 502 to implement various recovery and rerouting strategies as appropriate. In addition status monitor 506 also may collect performance indicators from each distributed switch in its domain for network performance monitoring and troubleshooting purposes.

Connection management system 500 further comprises a failover manager 508 to assist in the event of a Root Switch failure. Generally, a failure at a domain's Root Switch may not affect traffic already in transit, but subsequent link/switch failures may require updates to path tables at every switch in the domain. Failover manager 508 may thus be configured to select and assign a new connection manager (e.g. residing at a different server node) in the event of Root Switch failures. Such a selection may be administrative, based upon a consensus algorithm, or made in any other suitable manner. In the event that multiple domains are involved, a failure affecting inter-domain traffic may involve messaging across corresponding connection managers.

It will be understood that the connection management system of FIG. 5 is shown for the purpose of example and is not intended to be limiting in any manner, as any other suitable connection management system may be used to manage a direct network of server nodes.

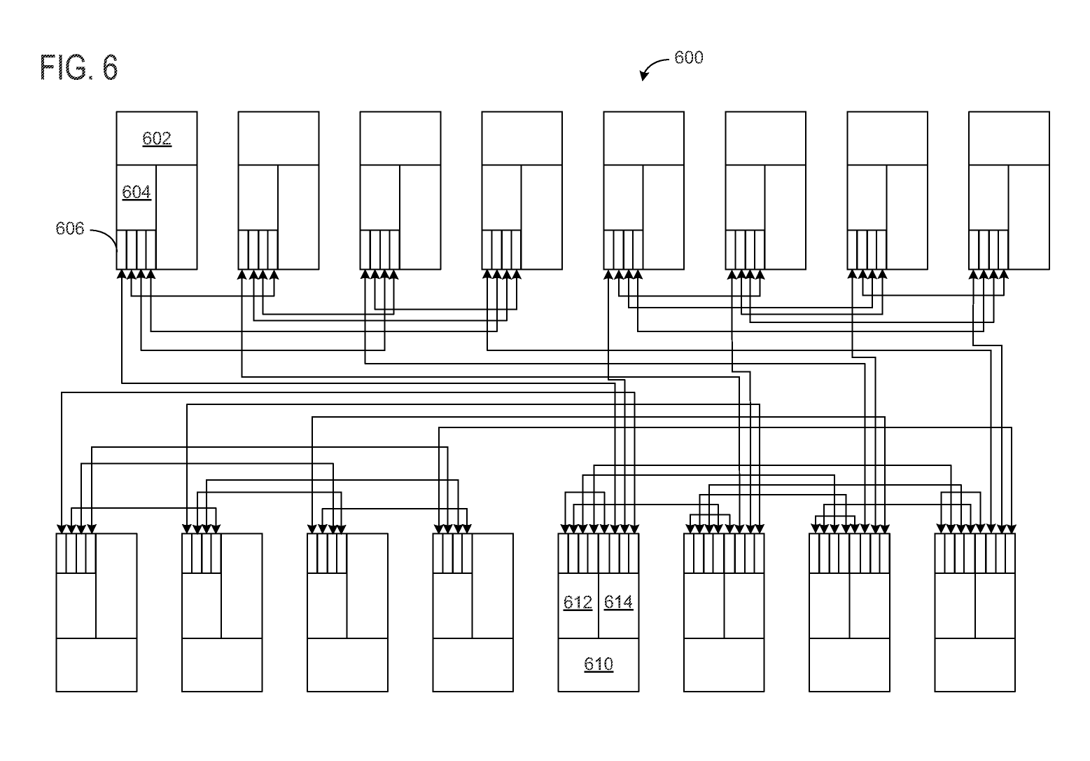

FIG. 6 shows an embodiment of an example network layout 600 used to test a direct network of server nodes. Example network layout 600 comprises sixteen host server nodes, such as example server node 602, and twenty switches, such as example switch 604, wherein each switch includes four Light Peak connections 606. Each host the test comprised a four-core Intel Xeon E55540 CPU, available from the Intel Corporation of Santa Clara, Calif., and was running the Microsoft Windows Server 2008 R2 operating system, available from the Microsoft Corporation of Redmond, Wash. To verify that transit traffic does not interrupt a host's CPU, four of the hosts, such as host 610, contained two switches 612, 614 such that one of the two switches was configured not to pass traffic into our out of the host.

The device driver implementation followed the Network Driver Interface Specification (NDIS) 6.20 connectionless miniport driver model, with a network layer Maximum Transmission Unit (MTU) of 4096 bytes. The device driver mapped a set of direct memory access buffers as a circular queue pair (one for the transmit side and one for the receive side) for each of the configured paths.

For sending, the device driver collected packets from the TCP/IP subsystem, selected a transmit queue based upon the destination IP address, and added the packet to the queue. For receiving, a packet was removed from a receive queue and forwarded to the TCP/IP layer. The arrival of a packet in the receive queue, completion of a buffer transmission, as well as a receive queue being full were indicated as interrupt events to the driver. With this prototype system, 5.5 Gbps transmit and 7.8 Gbps receive throughputs were achieved from each host server node.

The connection manager of the embodiment of FIG. 6, in addition to link layer path configuration, also implemented IP address assignment to host server nodes. As the Light Peak prototype interfaces lacked a globally unique identifier (such as an Ethernet MAC address), a globally unique identifier for the host (computer name) was used along with a locally unique identifier for the Light Peak network interface as a basis for IP address assignment.

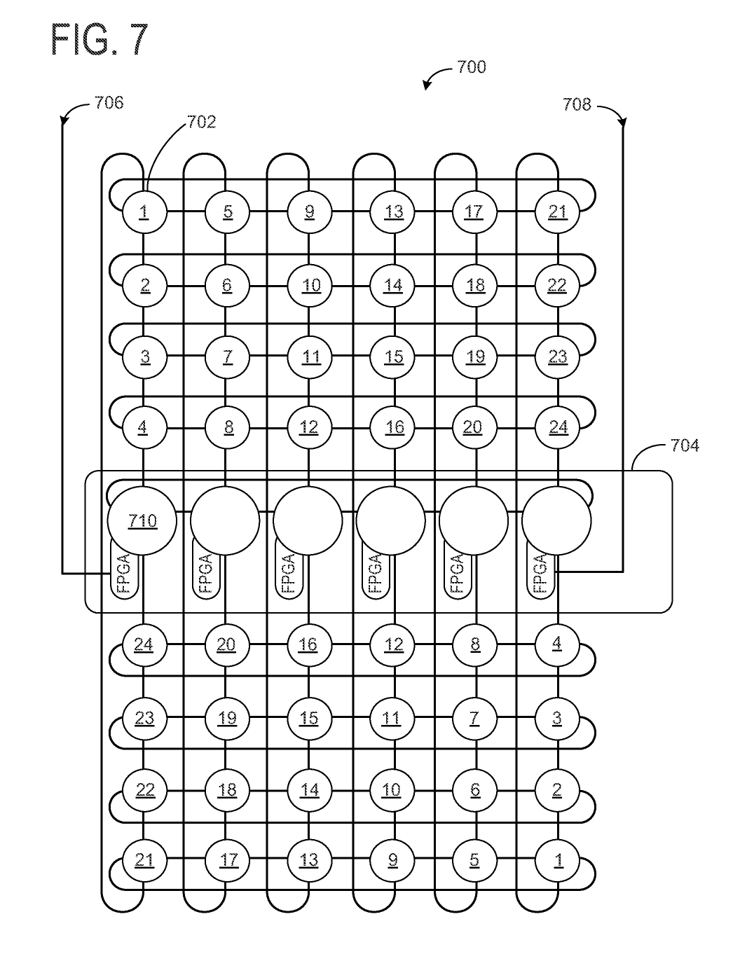

FIG. 7 shows another embodiment of a direct network arrangement for a multi-server unit 700. Multi-server unit 700 comprises forty eight server nodes 702 arranged in a mesh topography that is split into two halves separated by an FPGA board 704 such that each half has 24 nodes. FPGA board 704 further comprises two uplinks 706, 708 configured to connect to an external network. In one specific embodiment, uplinks 706, 708 may comprise 10 Gb Ethernet uplinks. In other embodiments, any other suitable uplinks may be used. In the embodiment of FIG. 7, server nodes within a half can talk any-to-any. When crossing from one half into the other, headers are added to data packets, and the data packets are directed to a PCIe port (an example of which is shown at 710) on FPGA board 704 for processing via FPGA. The FPGA strips the header, checks the packet, and sends it to a destination server node in the other half. Traffic to be sent external to multi-server unit 700 may be sent to FPGA board 704 in a similar manner. In this case, the FPGA strips the header and then encapsulates for transmission across the external Ethernet network.

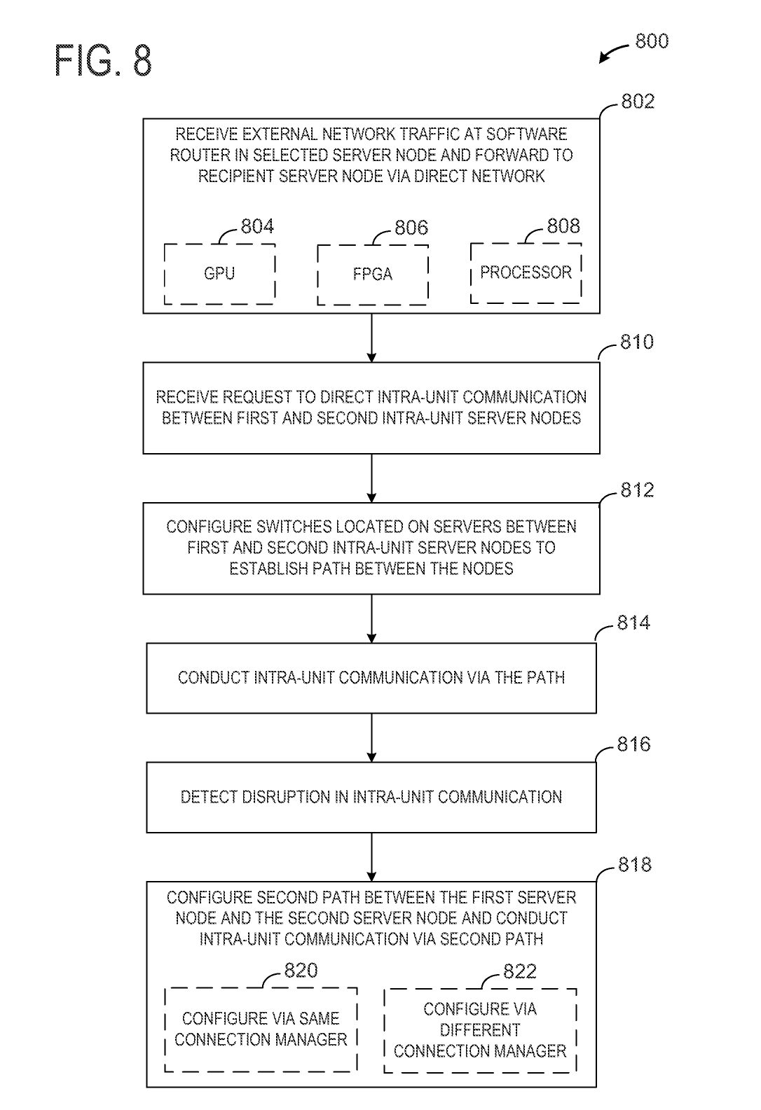

FIG. 8 shows a flow diagram depicting an embodiment of a method 800 of operating a multi-server unit. Method 800 comprises, at 802, receiving external network traffic at a software router running on a selected server node of the multi-server unit, and forwarding the traffic to an intended recipient server node within the multi-server unit via a direct network. The software router may be implemented via any suitable hardware, including but not limited to a GPU 804, an FPGA 806, and/or a CPU 808. Likewise, the network traffic may be forwarded to the intended recipient server node via any suitable type of direct network connection, including but not limited to a Light Peak connection. The external network may be any suitable type of network, including but not limited to 10 Gb Ethernet. It will be understood that network traffic also flows in an inverse direction to that shown at process 802, in that network traffic originating from within the multi-server unit may be received at the software router and then routed to an external network location by the software router.

Next, method 800 comprises, at 810, receiving a request to direct intra-unit communication between first and second intra-unit server nodes. Such a request may be received, for example, by a connection manager running on one of the server nodes of the multi-server unit. In response, at 812, the connection manager may configure switches located along a server node path between the transmitting server node and the recipient server node to establish a path between the server nodes. Intra-unit communication is then conducted at 814 along the path.

Next, at 816, a disruption is detected in the intra-unit communication, for example, due to a disruption of the path. In response, at 818, a second path between the first server node and the second server node is configured, and communication is then conducted along the second path. In some instances, for example, where the disruption is not due to the Root Switch, the second path may he configured by a same connection manager that configured the first path, as indicated at 820. In other instances, for example, where the disruption is due to an error of the Root Switch of the connection manager, the second path may be configured by a different connection manager, as indicated at 822.

The above-described embodiments thus may allow a data center to be upgraded in a cost-effective manner. Further, the above-described embodiments may be delivered to a data center in the form of a factory-configured field-replaceable unit comprising multiple servers, power management systems, and other components mounted to one or more racks or frames, that can be plugged into a same location in the data center network as a tree-based indirect network server pod without any modification to the upstream network. Further, while described herein in terms of a multi-server “pod” unit, it will be understood that a direct network of servers, or an array of direct server networks, may be configured to have any suitable size. For example, field replaceable units also may correspond to half-pods, to containers of multiple pods, and the like.

The above described methods and processes may be tied to a computing system including one or more computers. In particular, the methods and processes described herein may be implemented as a computer application, computer service, computer API, computer library, and/or other computer program product.

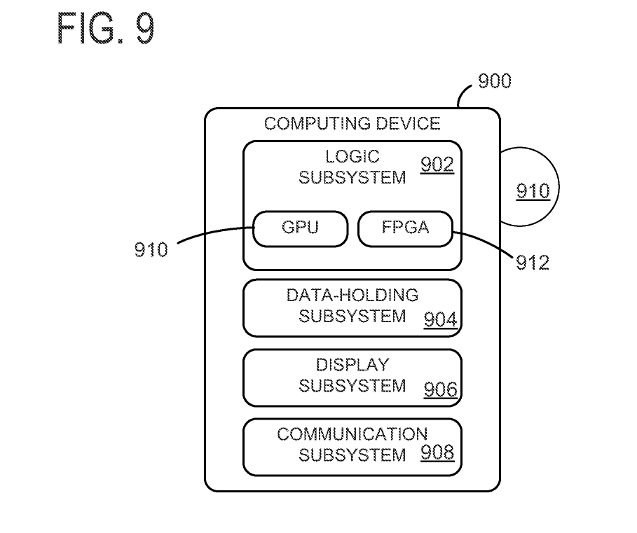

FIG. 9 schematically shows a nonlimiting computing system 900 that may perform one or more of the above described methods and processes. Computing system 900 is shown in simplified form. It is to be understood that virtually any computer architecture may be used without departing from the scope of this disclosure. In different embodiments, computing system 900 may take the form of a server computer, or any other suitable computer, including but not limited to a mainframe computer, desktop computer, laptop computer, tablet computer, home entertainment computer, network computing device, mobile computing device, mobile communication device, gaming device, etc.

Computing system 900 includes a logic subsystem 902 and a data-holding subsystem 904. Computing system 900 may optionally include a display subsystem 906, communication subsystem 908, and/or other components not shown in FIG. 9. Computing system 900 may also optionally include user input devices.

Logic subsystem 902 may include one or more physical devices configured to execute one or more instructions. For example, logic subsystem 902 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 902 may include one or more processors that are configured to execute software instructions. Additionally or alternatively, logic subsystem 902 may include one or more hardware or firmware logic machines configured to execute hardware or firmware instructions, including but not limited to the above-mentioned graphics processing unit 910 and/or field programmable gate array 912. Processors of logic subsystem 902 may be single core or multicore, and the programs executed thereon may be configured for parallel or distributed processing. Logic subsystem 902 may optionally include individual components that are distributed throughout two or more devices, which may be remotely located and/or configured for coordinated processing. One or more aspects of logic subsystem 902 may be virtualized and executed by remotely accessible networked computing devices configured in a cloud computing configuration.

Data-holding subsystem 904 may include one or more physical, non-transitory, devices configured to hold data and/or instructions executable by the logic subsystem to implement the herein described methods and processes. When such methods and processes are implemented, the state of data-holding subsystem 904 may be transformed (e.g., to hold different data).

Data-holding subsystem 904 may include removable media and/or built-in devices. Data-holding subsystem 904 may include optical memory devices CD, DVD, HD-DVD Blu-Ray Disc, etc.), semiconductor memory devices (e.g., RAM, EPROM, EEPROM, etc.) and/or magnetic memory devices (e.g., hard disk drive, floppy disk drive, tape drive, MRAM, etc.), among others. Data-holding subsystem 904 may include devices with one or more of the following characteristics: volatile, nonvolatile, dynamic, static, read/write, read-only, random access, sequential access, location addressable, file addressable, and content addressable. In some embodiments, logic subsystem 904 and data-holding subsystem 904 may be integrated into one or more common devices, such as an application specific integrated circuit or a system on a chip.

FIG. 9 also shows an aspect of the data-holding subsystem in the form of removable computer-readable storage media 914, which may be used to store and/or transfer data and/or instructions executable to implement the herein described methods and processes. Removable computer-readable storage media 914 may take the form of CDs, DVDs, HD-DVDs, Blu-Ray Discs, EEPROMs, and/or floppy disks, among others.

It is to be appreciated that data-holding subsystem 904 includes one or more physical, non-transitory devices. In contrast, in some embodiments aspects of the instructions described herein may be propagated in a transitory fashion by a pure signal (e.g., an electromagnetic signal, an optical signal, etc.) that is not held by a physical device for at least a finite duration. Furthermore, data and/or other forms of information pertaining to the present disclosure may be propagated by a pure signal.

The terms “module,” “program,” and “engine” may be used to describe an aspect of computing system 900 that is implemented to perform one or more particular functions. In some cases, such a module, program, or engine may be instantiated via logic subsystem 902 executing instructions held by data-holding subsystem 904. It is to be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” are meant to encompass individual or groups of executable files, data files, libraries, drivers, scripts, database records, etc.

It is to be appreciated that a “service”, as used herein, may be an application program executable across multiple user sessions and available to one or more system components, programs, and/or other services. In some implementations, a service may run on a server responsive to a request from a client.

When included, display subsystem 906 may be used to present a visual representation of data held by data-holding subsystem 904. As the herein described methods and processes change the data held by the data-holding subsystem, and thus transform the state of the data-holding subsystem, the state of display subsystem 906 may likewise be transformed to visually represent changes in the underlying data. Display subsystem 906 may include one or more display devices utilizing virtually any type of technology. Such display devices may be combined with logic subsystem 902 and/or data-holding subsystem 904 in a shared enclosure, or such display devices may be peripheral display devices.

When included, communication subsystem 908 may be configured to communicatively couple computing system 900 with one or more other computing devices. Communication subsystem 908 may include wired and/or wireless communication devices compatible with one or more different communication protocols, including but not limited to Ethernet and Light Peak protocols.

It is to be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A multi-server unit, comprising:
a plurality of server nodes connected in a direct network topology comprising distributed switching between the plurality of server nodes, each server node of the plurality of server nodes comprising a direct network switch, a data-holding subsystem and a logic subsystem, the plurality of server nodes including a router server node comprising
one or more ports configured to communicate with an outside network,
one or more ports configured to communicate with other server nodes of the plurality of server nodes,
and
instructions stored in the data-holding subsystem of the router server node and executable by the logic subsystem of the router server node to implement a router configured to direct traffic between the one or more ports configured to communicate with an outside network and the one or more ports configured to communicate with other server nodes of the plurality of server nodes.

2. The multi-server unit of claim 1, wherein the one or more ports configured to communicate with an outside network comprise Ethernet ports and wherein the one or more ports configured to communicate with the other server nodes comprise Light Peak ports.

3. The multi-server unit of claim 2, wherein the Ethernet ports are 10 Gb Ethernet ports.

4. The multi-server unit of claim 1, wherein the one or more ports configured to communicate with the other server nodes are Peripheral Component Interconnect Express ports.

5. The multi-server unit of claim 1, further comprising a plurality of optical connectors connecting the plurality of server nodes to form the direct network.

6. The multi-server unit of claim 1, further comprising a plurality of electrical connectors connecting the plurality of server nodes to form the direct network.

7. The multi-server unit of claim 1, wherein the direct network comprises one or more of a cube topology, a direct butterfly topology, a mesh topology, and a Caley graph topology.

8. The multi-server unit of claim 1, wherein the router server node comprises a field programmable gate array.

9. The multi-server unit of claim 1, wherein the router server node comprises a graphics processing unit.

10. The multi-server unit of claim 1, wherein the multi-server unit comprises forty eight server nodes.

11. The multi-server unit of claim 1, arranged in a field-replaceable unit.

12. The multi-server unit of claim 1, wherein one or more server nodes of the plurality of server nodes comprises instructions executable to implement a connection manager configured to control the distributed switching of the direct network.

13. A field-replaceable multi-server unit, comprising:
a plurality of server nodes each comprising a direct network switch connected via one or more of Light Peak connectors and Peripheral Component Interconnect Express connectors to one or more other server nodes in a direct network topology, the plurality of server nodes including a router server node comprising
one or more ports configured to communicate with an outside network;
one or more ports configured to communicate with other server nodes of the plurality of server nodes;
a logic subsystem, and
a data holding subsystem comprising instructions executable to implement a router to direct traffic between the one or more ports configured to communicate with an outside network and the one or more ports configured to communicate with other server nodes of the plurality of server nodes via the direct network.

14. The field-replaceable multi-server unit of claim 11 wherein the one or more ports configured to communicate with an outside network are configured to communicate with a 10 Gb Ethernet network.

15. The field-replaceable multi-server unit of claim 13, wherein the router server node comprises one or more of a field programmable gate array and a graphics processing unit.

16. A method of operating a multi-serer unit in a data center, the method comprising:
receiving external network traffic from an Ethernet network at a router implemented as software in a selected server node of the multi-server unit;
forwarding via the router the external network traffic to a recipient server node of the multi-server unit via a Light Peak connection;
receiving a request to direct intra-unit communication between an originating server node and a second server node of the multi-server unit; and
configuring one or more switches located on one or more server nodes between the first server node and the second server node to establish a first path between the first server node and the second server node and then conducting intra-unit communication via the path.

17. The method of claim 16, further comprising detecting a disruption in the intra-unit communication, and in response, configuring a second path between the first server node and the second server node.

18. The method of claim 16, wherein configuring the one or more switches comprises configuring the one or more switches via a first connection manager, and further comprising, after configuring the one or more switches via the first connection manager, configuring a second path between a third server node and a fourth server node via a second connection manager operating on a different server node than the first connection manager.

19. The method of claim 16, wherein forwarding the external network traffic via the router comprises utilizing a graphics processing unit.

20. The method of claim 16 wherein forwarding the external network traffic via the router comprises utilizing a field programmable gate array.
